(19) United States
(12) Patent Application Publication
(10) Pub. No.: US 2016/0350499 A1
(43) Pub. Date: Dec. 1, 2016

(54) SYSTEM AND METHOD FOR OPTIMIZING ALLOCATION OF MEDICAL UNITS FOR PATIENT TREATMENT

(71) Applicant: INTERNATIONAL BUSINESS MACHINES CORPORATION, Armonk, NY (US)

(72) Inventors: HAMIDEH ANJOMSHOA, Melbourne (AU); Irina Dumitrescu, Carlton (AU); Irvin Lustig, Short Hills, NJ (US); Olivia Smith, Melborne (AU)

(21) Appl. No.: 14/726,206

(22) Filed: May 29, 2015

(51) Int. Cl. G06F 19/00

(52) U.S. Cl. CPC G06F 19/327

(57) ABSTRACT

A method for optimizing allocation of surgical resources includes receiving a set of input parameters including a schedule of operating room availability, a list of surgery departments, and a list of patients waiting for surgery. Historical operating room usage data and historical patient waiting list data are received. An operating room usage model is based on the received historical operating room usage data and the historical patient waiting list data. A future operating room availability is scheduled. A set of operating room resources required for each of the patients waiting for surgery is scheduled. A schedule for future operating room usage is generated to accommodate the list of surgery department, the list of patients, and the scheduled future operating room availability by optimizing an assignment of each of the patients and respective scheduled set of operating room resources required.

### TECHNICAL FIELD

Exemplary embodiments of the inventive concept relate to medical unit allocation, and more particularly, to systems and methods for optimizing allocation of medical units for patient treatment.

DISCUSSION OF THE RELATED ART

Patients who need surgery may be sorted into different priority categories based on factors such as the type of surgery that each patient needs, the patients' age, health condition, and the like. The patient priority categories may have different levels of urgency associated therewith. The number of days in which a patient should have surgery within may be established by guidelines. For example, a first patient sorted in a first category may need to have surgery within 30 days, and a second patient sorted in a second category may need to have surgery within 60 days. Hospital performance may be rated based on the amount of patients that are treated within their respective time periods, as dictated by the guidelines. Patients who are not operated within their respective time periods (e.g., are overdue) may negatively affect a hospital's performance rating.

Hospitals may schedule surgeries on a first-come first-served basis. Modifying a hospital's surgery schedule after it has been generated may be difficult because operating room times, doctor availability, hospital bed availability, and the like, may need to be re-coordinated. Scheduling surgeries on a first-come first-served basis may result in filling a hospital's surgery schedule with patients who may have longer periods of time in which to have their surgery performed according to the guidelines. However, patients having shorter periods of time in which to have their surgery performed may enlist for surgery when the hospital's surgery schedule may be filled. Thus, these patients may have to wait for surgery for a period of time in excess of what is permitted under the guidelines. As a result, patients' care and the hospital's performance rating may be negatively affected.

### SUMMARY

An exemplary embodiment of the present inventive concept relates to a method of generating a future surgery schedule optimizing simultaneous allocation of surgical resources and selection of patients for surgery. Optimizing simultaneous allocation of surgical resources and selection of patients for surgery may include using a mathematical optimization method. The mathematical optimization method may use a set of inputs including a patient list and a preliminary surgery schedule, hospital objectives and hospital constraints. A constraint may include allocating surgical resources within the hospital's budget. An objective may include achieving good hospital performance. Surgical resources may include surgeons, operating room time, intensive care unit (ICU) bed time, ward bed time, and the like.

The generated surgery schedule may allocate surgical resources for each day of a predetermined time period and select which patients may have surgery on a particular day for each day of the predetermined time period.

According to an exemplary embodiment of the present inventive concept, a method for optimizing allocation of surgical resources includes receiving a set of input parameters including a schedule of operating room availability, a list of surgery departments, and a list of patients waiting for surgery and the type of surgery they are waiting for. The list of patients waiting for surgery includes patients waiting for a plurality of different types of surgery. Historical operating room usage data is received. Historical patient waiting list data is received. An operating room usage model is based on the received historical operating room usage data and the received historical patient waiting list data. Future operating room availability is scheduled based on the list of patients waiting for surgery and the operating room usage model. A set of operating room resources required for each of the patients on the list of patients waiting for surgery is scheduled based on the received historical operating room usage data. A schedule for future operating room usage is generated to accommodate the list of surgery departments, the list of patients waiting for surgery, and the scheduled future operating room availability by optimizing an assignment of each of the patients waiting for surgery based on respective surgery types and respective scheduled set of operating room resources required.

According to an exemplary embodiment of the present inventive concept, generating the schedule for future operating room usage may include allocating operating room time to surgeons or departments, and selecting types of patients to be treated.

According to an exemplary embodiment of the present inventive concept, the set of input parameters may additionally include operation urgency data for each patient on the list of patients waiting for surgery and optimizing the assignment of each patient waiting for surgery may include consideration of the operation urgency data.

According to an exemplary embodiment of the present inventive concept, the set of input parameters may additionally include a user-specified degree of relative priority for each patient on the list of patients waiting for surgery and optimizing the assignment of each patient waiting for surgery may include consideration of the user-specified degree of relative priority.

According to an exemplary embodiment of the present inventive concept, the scheduled future operating room availability may include a number of predicted available hospital beds over time, the scheduled set of operating room resources required for each of the patients may include a prediction of a number of days in which a hospital bed may be required, and optimizing the assignment of each patient waiting for surgery may include consideration of the number of predicted available hospital beds over time and the prediction of a number of days in which a hospital bed may be required for each patient.

According to an exemplary embodiment of the present inventive concept, the received set of input parameters may include data indicating how long each patient on the list of patients waiting for surgery has been waiting for surgery for and optimizing the assignment of each patient waiting for surgery may include consideration of the data indicating how long each patient on the list of patients waiting for surgery has been waiting for surgery for.

According to an exemplary embodiment of the present inventive concept, the received set of input parameters may include data describing requirements for maximum waiting times for surgery and optimizing the assignment of each patient waiting for surgery may include ensuring the requirements concerning maximum waiting time for surgery are met.

According to an exemplary embodiment of the present inventive concept, optimizing the assignment of each patient waiting for surgery may include making a determination that the generated future operating room schedule is insufficient to schedule all patients of the list of patients waiting for surgery and generating a list of changes that would increase the generated future operating room schedule to a point at which it may be sufficient to schedule all patients of the list of patients waiting for surgery.

According to an exemplary embodiment of the present inventive concept, the list of changes that would increase the generated future operating room schedule may be automatically generated and an impact of the list of changes that would increase the generated future operating room schedule may be assessed.

According to an exemplary embodiment of the present inventive concept, the schedule of operating room availability received as part of the input parameters may include data pertaining to what types of surgeries are performable in each operating room.

According to an exemplary embodiment of the present inventive concept, the historical operating room usage data may include information pertaining to past operating room availability, operating room time required to perform each type of operation, and extent of hospital stay associated with each type of operation.

According to an exemplary embodiment of the present inventive concept, the optimizing of the assignment of each of the patients waiting for surgery may be performed by solving a mathematical optimization problem using an optimization solver.

According to an exemplary embodiment of the present inventive concept, the scheduled future operating room availability may include a number of predicted available intensive care unit (ICU) hospital beds over time, the scheduled set of operating room resources required for each of the patients includes a prediction of a number of days in which an ICU hospital bed is required, and optimizing the assignment of each patient waiting for surgery may include consideration of the number of predicted available ICU hospital beds over time and the prediction of a number of days in which an ICU hospital bed may be required for each patient.

According to an exemplary embodiment of the present inventive concept, the types of surgery may be clustered into clusters of similar surgery types for similar treatment by the optimization of the assignment of each of the patients waiting for surgery.

According to an exemplary embodiment of the present inventive concept, the set of input parameters may additionally include surgeon specialty availability data and surgeon specialty requirements for each surgery type and optimizing the assignment of each patient waiting for surgery may include consideration of the surgeon specialty availability data and the surgeon specialty requirements for each surgery type.

According to an exemplary embodiment of the present inventive concept, the list of patients waiting for surgery may include patients forecasted using the historical operating room usage data and statistical mathematical modeling.

According to an exemplary embodiment of the present inventive concept, a computer system includes a processor, and a non-transitory, tangible, program storage medium, readable by the computer system, embodying a program of instructions executable by the processor to perform method steps for optimizing allocation of surgical resources. The method includes receiving a set of input parameters including a schedule of operating room availability. A list of patients waiting for surgery and the type of surgery they are waiting for is received. Operation urgency data for each patient on the list of patients waiting for surgery is received. An indication of hospital bed availability is received. Historical operating room usage data is received. Operating room usage is modeled based on the received historical operating room usage data. Future operating room availability is scheduled based on the list of patients waiting for surgery and the operating room usage model. A set of operating room resources required for each of the patients on the list of patients waiting for surgery is scheduled based on the received historical operating room usage data. A schedule for future operating room usage is generated based on the list of patients waiting for surgery, the operation urgency data, the indication of hospital bed, and the scheduled future operating room availability by optimizing an assignment of each of the patients waiting for surgery based on respective surgery types and respective scheduled set of operating room resources required.

According to an exemplary embodiment of the present inventive concept, the received set of input parameters may further include data indicating how long each patient on the list of patients waiting for surgery has been waiting for surgery for and optimizing the assignment of each patient waiting for surgery may include consideration of the data indicating how long each patient on the list of patients waiting for surgery has been waiting for surgery for.

According to an exemplary embodiment of the present inventive concept, the optimizing of the assignment of each of the patients waiting for surgery may be performed by solving a mathematical optimization problem using an optimization solver.

According to an exemplary embodiment of the present inventive concept, the list of patients waiting for surgery may include patients forecasted using the historical operating room usage data and statistical mathematical modeling.

### BRIEF DESCRIPTION OF THE DRAWINGS

The above and other features and aspects of the inventive concept will become more apparent by describing in detail exemplary embodiments thereof with reference to the accompanying drawings, in which:

FIG. 1 is a flow chart illustrating a method for optimizing allocation of surgical resources according to an exemplary embodiment of the inventive concept;

FIG. 2 shows an example of a computer system which may perform the method and system of FIG. 1, according to an exemplary method of the inventive concept;

FIG. 3 is a flow chart illustrating steps of a method and system that may optimize patient selection and allocation of operating room resources needed for the patients' surgeries, according to an exemplary method of the inventive concept;

FIG. 4 is a block diagram illustrating the contents of the prediction inputs 300 of the method illustrated FIG. 3, according to an exemplary embodiment of the inventive concept;

FIG. 5 is a block diagram illustrating the optimization inputs 330 of the method illustrated in FIG. 3, according to an exemplary embodiment of the inventive concept; and

FIG. 6 is a block diagram illustrating contents of the prediction outputs 320 of the method illustrated FIG. 3, according to an exemplary embodiment of the inventive concept.

### DETAILED DESCRIPTION OF THE EMBODIMENTS

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

The flowcharts and/or block diagrams in the figures illustrate the architecture, functionality, and operation of possible implementations of systems, methods, and computer program products according to various exemplary embodiments of the inventive concept. In this regard, each block in the flowchart or block diagrams may represent a module, segment, or portion of instructions, which comprises one or more executable instructions for implementing the specified logical function(s). In alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A preliminary surgery schedule may be created for a hospital or surgery center to cover a predetermined amount of time. The preliminary surgery schedule may allocate operating room availability for operating patients over a time span. The preliminary surgery schedule may be based on such factors as the hospital's budget, surgeon availability, operating room availability, and a list of patients needing surgery. While the preliminary schedule may be manually modified to some extent, for example, to rearrange scheduling to fit in an urgent surgery, such modifications can be difficult and time consuming as the changes made can require a significant change to the schedules of a large number of medical practitioners and patients.

According to exemplary embodiments of the present invention, schedule for future operating room usage may be generated using input data including the preliminary surgery schedule, objectives and constraints. The schedule for future operating room usage may be optimized using mathematical optimization techniques that consider the input data including the preliminary surgery schedule, hospital objectives, and constraints.

The input data may include the preliminary surgery schedule, a list of patients waiting for surgery, operating room availability, surgeon availability, intensive care unit (ICU) beds, ward beds, and the like.

The list of patients waiting for surgery may include actual patients and forecasted patients. The forecasted patients may be estimated using statistical mathematical modeling and historical operating room usage data and historical patient waiting list data. Historical operating room usage data may include a list of previously operated patients, the amount of time the previously operated patients spent on a waiting list waiting for the operation, what type of operation the previously operated patients had, how long their respective surgical procedures took, how long each previously operated patient took recover including ICU bed time and ward bed time, and the like. The historical patient waiting list data may include, for a past period of time, a number a patients that waited for surgery on a waiting list, a time when each patient enlisted for surgery, a type of surgery that each patient needed, a time when each patient actually had surgery, an amount of time each patient on the waiting list waited to have surgery, each patient's urgency category, a time limitation for each patient to have surgery within prescribed surgery guidelines time limitations, data indicating whether each patient had surgery within the time limitation for surgery prescribed by the guidelines, a recovery rate for each patient, how long each patient occupied and ICU and/or ward bed, and the like.

Hospital objectives may include maximizing hospital revenue, maximizing the number of patients that may have surgery before the end of a predetermined time span (e.g., operate patients on time), and the like. The hospital may give different weight to the plurality of hospital objectives.

The constraints may consider the number of patients that need surgery, the number of available sessions, the surgeons' availability, ward and ICU bed availability, limit on the number of sessions to each department, and the like. The mathematical optimization may be performed using an optimization solver.

Generating the schedule for future operating room usage may include selecting which patients may have surgery and allocating operating room resources needed for the patients' surgeries (e.g., operating rooms, sessions, surgeons including specialists, ICU beds, ward beds, and the like) using mathematical optimization. A session may be a block of time in an operating room during which one or more surgeries may be consecutively performed.

Optimizing patient selection and allocating operating room resources needed for the patients' surgeries may include determining that the predicted future operating room availability is insufficient to schedule all patients of the list of patients waiting for surgery and generating a list of changes that would increase the predicted future operating room availability to a point at which it is sufficient to schedule all patients of the list of patients waiting for surgery.

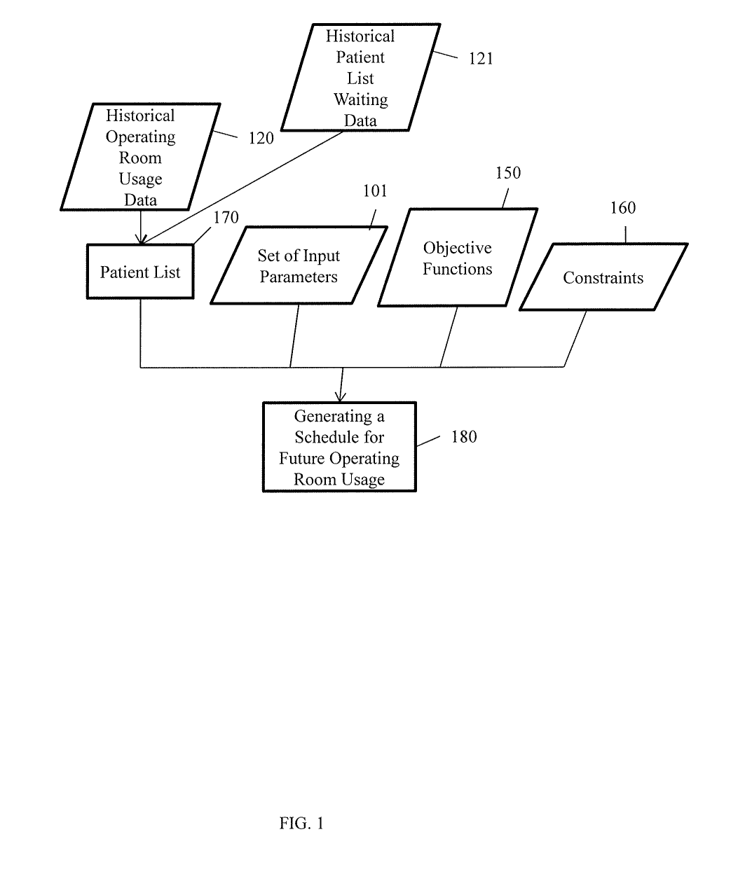

FIG. 1 is a flow chart illustrating a method for generating a schedule that may optimize patient selection and allocation of surgical resources, according to an exemplary embodiment of the inventive concept.

For a past period of time in a hospital, historical operating room usage data 120 may include, for example, a number of patients who had surgery, when each of the patients enlisted for surgery, a time period for each patient to have the surgery performed, each patient's actual surgery date, the medical unit that performed the surgery on each patient, the duration of each patient's surgery, the duration of ICU bed recovery for each patient, the duration of ward bed recovery for each patient, related cost and fund for each patient, and the like. The historical operating room usage data 120 may include other data as well.

Historical patient waiting list data 121 may include, for a past period of time, a number a patients that waited for surgery on a waiting list, a time when each patient enlisted for surgery, a type of surgery that each patient needed, a time when each patient actually had surgery, an amount of time each patient on the waiting list waited to have surgery, each patient's urgency category, a time limitation for each patient to have surgery within prescribed surgery guidelines time limitations, data indicating whether each patient had surgery within the time limitation for surgery prescribed by the guidelines, a recovery rate for each patient, how long each patient occupied and ICU and/or ward bed, and the like.

Actual patients waiting for surgery and the type of surgery they are waiting for, and predicted patients that may need surgery in the future and the type of surgery they may need may be included in a patient list 170. The predicted patients are patients that may be forecasted and may be added to the patient list 170. Generating the patient list 170 may include adding the actual patients (e.g., actual patient types) waiting for surgery when the patient list 170 is created. For example, the patient list 170 may be created. A list of actual patients waiting for surgery and the type of surgery they are waiting for may be added to the empty patient list 170. Predicted patients (e.g., predicted patient types) may be then forecasted and added to the patient list 170 using the historical operating room usage data 120 as input and statistical mathematical modeling. Statistical mathematical modeling using the historical operating room usage data 120 as input may be used to forecast a number of predicted patients over for a predetermined time period P that may be added to the patient list 170.

As described herein, e_{s,p} may represent a number of actual patients of the patient list 170 waiting for a surgery type s∈S in a time period p∈P^{past}, while a_{s,p} may represent the predicted patients of the patient list 170 in a period p∈P to have a surgery s∈S.

For each of the predicted patients of the patient list 170, the type of surgery that may be needed, a time when each predicted patient may enlist (e.g., be added to the patient list 170) for surgery, an urgency category and a respective time period in which to have surgery, and the like, may be determined using statistical mathematical modeling and historical operating room usage data 120. The patient list 170 may further include, for each of the actual and predicted patients of the predicted patients list 170, an amount of funds received by a healthcare provider for surgery, an expected revenue generated from the funds received for the operation, an expected length of surgery time, a probability of using an ICU bed after surgery and a predicted length of time that that the ICU bed may be needed, a probability of using a ward bed after surgery and the predicted length of time that each predicted patient may use the ward bed, and the like.

As described herein, W may represent a set of wards. As described herein, b_{w,p} may represent the number of beds available in a ward w in a time period p∈P.

The patient list 170 may include clusters of similar surgery types for each of the actual and predicted patients of the patient list 170. For example, a first predicted patient may need surgery to remove a lump under the skin in the first predicted patient's right arm. A second actual patient may need surgery to remove a lump in the second actual patient's left leg. Although the first predicted patient's and the second actual patient's surgery types may be different due to the location of the surgery, they may be included in the same cluster (e.g., general surgery cluster) due to the similarity of the surgical procedures. Each surgery type of a cluster of surgery types may need to be performed by a medical unit including a specialist type having a corresponding specialization. As described herein, S may represent a set of surgery types. S_{d}⊂S may represent a set of surgery types associated with a medical unit d∈D. S_{f}⊂S may represent a set of surgery types that may require a specialist f∈F. S_{c}⊂S may represent a set of surgery types that may have an urgency category c∈C. For a specialist f∈F_{d}, a set of surgery types may be represented by S_{f}⊂S.

As described herein, τₛ may represent a duration of a surgery s, measured in minutes, for any given surgery s∈S. LOSₛ may represent the length of stay of an actual or predicted patient from the list of predicted patients 170 associated with a surgery s, in days. Rₛ, may represent an expected revenue that a hospital may receive for performing a surgery s∈S.

For each of the actual and predicted patients on the patient list 170, ICUₛ may represent a probability of a surgery of a type s∈S needing ICU time (e.g., an ICU bed). N^{ICU} may represent the ICU daily patient capacity.

A set of input parameters 101 may include a preliminary surgery schedule 102. The preliminary surgery schedule 102 may be a schedule of surgeries allocated to a medical unit of a hospital for each day of a predetermined amount of time. A surgery session may be an amount of time during which one or more consecutive surgeries may be performed in an operating room of a hospital. The surgery session may be, for example, ½ hour, 1 hour, 2 hours, 3 hours, 4 hours, 8 hours long, or the like. However, the length of time of a surgery session is not limited thereto. The maximum amount of sessions that a hospital may allocate to medical units may be restricted by the hospital's budget.

A set of input parameters 101 may include a list of surgery departments 112. The list of surgery departments 112 may include all the surgery departments of a hospital. Each surgery department of the hospital may include a number of specialists corresponding to the surgery department and the types of surgeries that each specialist may perform. A surgery department may perform more than one type of surgery.

The set of input parameters 101 may include a set of urgency categories 105. The set of urgency categories 105 may include, for example, category 1, category 2, and category 3 urgencies. However, exemplary embodiments of the inventive concept are not limited thereto. According to an exemplary embodiment of the inventive concept, the set of input parameters 101 may include more than three urgency categories or less than three urgency categories. A category 1 urgency of the set of urgency categories 105 may be the most urgent category type among categories 1, 2, and 3 of the set of urgency categories 105. A category 3 urgency may be the least urgent category type among categories 1, 2, and 3 urgencies of the set of urgency categories 105. The set of the category 1, category 2, and category 3 urgencies of the set of urgency categories 105 may be represented by: C={1,2,3}. For example, a category 1 patient may need surgery within 30 days of being added to the patient list 170 as an actual or predicted patient. A category 2 patient may need surgery within 60 days of being added to the patient list 170 as an actual or predicted patient. A category 3 patient may need surgery within 365 days of being added to the patient list 170 as an actual or predicted patient. However, surgery time periods of category 1, category 2, and category 3 patients are not limited thereto. Further, the set of input parameters 101 may include user-specified degree of relative priority 111 for each patient. The user-specified degree of relative priority may be a manually received input which may set a surgery priority rank for each patient waiting for surgery.

The set of input parameters 101 may include a time period P over which an optimized schedule for future operating room usage 180 may be generated. According to an exemplary embodiment of the inventive concept, the time period P may include 28 days. P={1, . . . , |P|} may represent a time period P for which a schedule for future operating room usage 180 may be generated. P^{past}={−max_{c∈C} L_{c}, . . . , 0} may represent a set of past time periods with respect to the beginning of the predetermined time P, going back the maximum number of time periods that a patient may spend on the patient list 170 without exceeding the patient's respective time period in which to have surgery performed. Since category 3 is the least urgent category of the set of urgency categories 105, the set of past time periods with respect to the beginning of the predetermined time P, going back the maximum number of time periods (e.g., days) that a patient may spend on the patient list 170 without exceeding the respective patient's respective time period to have surgery performed, may be represented by P^{past}={−L₃, . . . , 0}.

The set of input parameters 101 may include data indicating how long each actual and predicted patient of the patient list 170 may have waited for surgery. The amount of time that each actual and predicted patient of the patient list 170 may have waited for surgery may be determined by comparing a reading date of when the determination of how long each actual and predicted patient of the patient list 170 is made to the enlistment date if each respective actual and predicted patient.

The set of input parameters 101 may include an availability of operating rooms 115. The availability of operating rooms 115 may include a list of operating rooms, and for each of the operating rooms in the list in may include an availability date and blocks of time during which each respective operating room may be used for each availability date. The availability of operating rooms 115 may also include the types of surgeries that may be performed in each operating room.

The set of input parameters 101 may include a limit of changes 103 that may be made to the preliminary surgery schedule 102. The limit of changes 103 that may be made to the preliminary surgery schedule 102 may include a maximum number of sessions that may be added over the predetermined time period |P|, a maximum number of sessions that may be deleted over the predetermined time period |P|, a maximum number of total changes (e.g., additions and deletions) over the predetermined time period |P|, and the like. However, exemplary embodiments of the inventive concept are not limited thereto. As described herein, MAX^{SESS} may represent the maximum number of sessions that the hospital may provide during the predetermined time period |P|. As described herein, N_{d,p}^{SESS} may represent the number of sessions allocated to a medical unit d∈D in a time period p∈P in the preliminary surgery schedule 102. As described herein, MAX^{add} may represent the maximum number of sessions that may be added to the preliminary surgery schedule 102 provided by the hospital during the predetermined time period P. As described herein, MAX^{del} may represent the maximum number of sessions that may be deleted from the preliminary surgery schedule 102 provided by the hospital during the predetermined time period P. As described herein, MAX^{chg} may represent the maximum number of changes to the preliminary surgery schedule 102 provided by the hospital during the predetermined time period P (e.g., the total number of sessions added and sessions deleted).

As described herein, N^{OT} may represent the number of operating rooms in a hospital. num_sessions may represent the number of sessions that may be hosted by each operating room of a hospital in a time period (e.g., a day). For example, a first operating room of a hospital may host 2 sessions in a day but a second operating room of the same hospital may host 1 session in a day. Accordingly, num_sessions may vary for each operating room of the hospital. In the case when the number of sessions that may be hosted by a hospital varies between the operating rooms, num_sessions may be indexed.

The set of input parameters 101 may include a method for assessing hospital performance rating 104. Assessing hospital performance rating 104 may include comparing a number of patients (e.g., actual and predicted patients of the predicted waiting list 170) that may have surgery before their respective time periods to have surgery performed and a number patients that may have surgery after their respective time periods to have surgery performed.

The set of input parameters 101 may include a set of medical departments 106. The set of medical departments 106 may include various medical units. D may represent a set of medical units. D_{d} may represent a maximum number of sessions that may be allocated to a medical unit d∈D in a time period (e.g., a day). Each medical unit d∈D may include various specialists.

Each medical unit may consider (e.g., perform surgery on) different types of patient groups. The various patient groups of each medical unit may be generated from the historical operating room usage data 120 using statistical mathematical models and expert opinions. An expert opinion may be an opinion of a person who may analyze the historical operating room usage data 120 and may predict patient of the patient list 170 that may enlist for surgery for surgery in each medical unit using the historical operating room usage data and/or statistical mathematical modeling. The expert opinion may forecast predicted patients of the patient list 170 and may sort the predicted patients into a plurality of patients groups of each medical unit, for all the available medical units.

A specialist may be a surgeon that may meet a specialty requirement for performing a type of surgery. As described herein, F may represent a set of available specialists. The specialists of the set of medical departments 106 may be categorized into specialist types. As described herein, F_{f,p} may represent the maximum availability of specialists f in a time period p measured in sessions.

Each specialist type may perform a corresponding surgery type. For example, a first specialist type of the set of medical departments 106 may include first and second specialized surgeons who may perform heart surgery. A second specialist type of the set of medical departments 106 may include third, fourth, and fifth specialized surgeons who may perform plastic surgery. As described herein, F_{d}⊂F may refer to a subset of the sets of specialists f in a medical unit d∈D.

The set of input parameters 101 may include a daily post-treatment capacity 107 (e.g., ICU and ward beds capacity/availability), measured in a number of patients. One patient (e.g., ICU patient) may need one bed (e.g., one ICU bed). After surgery, a first actual or predicted patient of the patient list 170 may need an ICU bed, for example, for four days. After needing the ICU bed, the first actual or predicted patient of the patient list 170 may need a ward bed, for example, for five days. However, exemplary embodiments of the inventive concept are not limited thereto.

As described herein, X_{d,p} may represent the number of allocated sessions for a medical unit d∈D in a time period p∈P. As described herein, θ_{s,p} may represent the number of actual and predicted patients from the patient list 170 who had a surgery s∈S during a time period p∈P. As described herein, θ_{s,p}⁺ may represent the total number of actual and predicted patients of the patient list 170 who had a surgery s on time (e.g., not overdue) during a time period p∈P. As described herein, θ_{s,p}⁺ may represent the total number of overdue patients, from among the actual and predicted patients of the patient list 170, who underwent a surgery s in a time period p. As described herein, Ω_{s,p}⁺ may represent the number of actual and predicted patients of the patient list 170 who need a surgery s∈S at the end of the time period p, who are on time (e.g., not overdue). As described herein, Ω_{s,p}⁻ may represent the number of overdue patients (e.g., actual and predicted patients of the patient list 170) who need a surgery s∈S and are on the predicted patient waiting list 170 at the end of the time period p. As described herein, Ω_{s,p} may represent the number of overdue patients, from among the actual and predicted patients of the patient list 170, who need a surgery s∈S and are overdue at the beginning of a time period p (e.g., a number of actual and predicted patients of the patient list 170 at the end of a period p-1 to which we add the new arrivals on an overdue list at the beginning of a time period p). As described herein, v_{d,p}^{add} may represent the number of added sessions in a time period p∈P for a medical unit d∈D. As described herein, v_{d,p}^{del} may represent the number of deleted sessions in a time period p∈P for a medical unit d∈D.

Generating a schedule for future operating room usage 180 may include optimizing a selection of patients 181 and allocating operating room resources 182, using the patient list 170, the set of input parameters 101, objective functions 150, and constraints 160.

A selection of patients 181 may include selecting one or more patients, from among the plurality of actual and predicted patients of the patient list 170, to have surgery in a time period such as, for example, a day.

Allocating operating room resources 182 may include allocating hospital resources, such as, for example, operating rooms, sessions, surgeons, specialists, ICU beds, ward beds, and the like. However, allocating operating room resources 182 is not limited thereto.

Mathematical optimization is a mathematical method for selecting one of the best choices, from among a plurality of available choices, using input selection criteria. Optimizing a selection of patients 181 may include generating a schedule for future operating room usage 180 including one of the best selection of patients 181 for surgery, from among a plurality of actual and predicted patients of the patient list 170, and one of the best allocation of operating room resources 182, from among a plurality of available allocation of operating rooms, sessions, surgeons, specialists, ICU beds, ward beds, and the like, using the patient list 170, the set of input parameters 101, objective functions 150, and constraints 160. According to an exemplary embodiment of the inventive concept, generating a schedule for future operating room usage 180 may include simultaneously selecting patients 181 and allocating operating room resources 182, using optimization.

The objective functions 150 may include achieving one or more objectives of a hospital in generating the schedule for future operating room usage 180. A first objective of the objective functions 150 may consider achieving a small (e.g., lowering) number of actual and predicted patients of the patient list 170 that may have exceeded their period of time in which to have surgery performed at the end of the predetermined time period P. The first objective of the objective functions 150 may be represented by:

$${Z}^{-} = {\sum }_{s ∈ S} {Ω}_{s , \vert P \vert}^{-} \qquad [ Equation 1 ]$$

A second objective of the objective functions 150 may include achieving a small number of actual and predicted patients of the patient list 170 at the end of the predetermined time period P. The second objective of the objective functions 150 may be represented by:

$${Z}^{+} = {\sum }_{s ∈ S} {Ω}_{s , \vert P \vert}^{+} \qquad [ Equation 2 ]$$

A third objective of the objective functions 150 may include generating a large revenue (e.g., the hospital's revenue) from the scheduled surgeries. The third objective of the objective functions 150 may be represented by:

$${Z}_{R} = {\sum }_{s ∈ S} {\sum }_{p ∈ P} {Ω}_{s , p} \times {R}_{s} \qquad [ Equation 3 ]$$

However, exemplary embodiments of the inventive concept are not limited thereto.

The first, second, and third objectives of the objective functions 150 may be considered by the hospital. However, one or more of the first, second, and third objectives of the objective function 150 might not be considered by the hospital. In addition, the importance that the hospital may attach to each of the first, second, and third objectives may vary. The first, second, and third objectives of the objective function 150, having varying importance, may be represented in an objective function:

min weight₁×Z⁻+weight₂×Z⁺×weight₃×Z_{R} [Equation 4]

The constraints 160 may include a plurality of constraints that may be considered in generating the schedule for future operating room usage 180.

A first constraint of the constraints 160 may include ensuring that the number of sessions allocated does not exceed the hospital capacity. The first constraint of the constraints 160 may be represented by:

$${\sum }_{d ∈ D , p ∈ P} {X}_{d , p} \leq {MAX}^{SESS} \qquad [ Equation 5 ]$$

A second constraint of the constraints 160 may include ensuring that, for each time period p∈P, the number of sessions allocated to a medical unit is the number of sessions allocated to the same medical unit in the preliminary surgery schedule 102 minus the number of sessions deleted plus the number of sessions added. The second constraint of the constraints 160 may be represented by:

X_{d,p}−v_{d,p}^{del}+v_{d,p}^{add}=N_{d,p}^{SESS}∀d∈D, p∈P [Equation 6]

A third constraint of the constraints 160 may include ensuring that the total number of added sessions across medical units and all time periods of the predetermined time period P does not exceed the maximum number of additions allowed MAX^{add}. The third constraint of the constraints 160 may be represented by:

$${\sum }_{d ∈ D , p ∈ P} {v}_{d , p}^{add} \leq {MAX}^{add} \qquad [ Equation 7 ]$$

A fourth constraint of the constraints 160 may include ensuring that the total number of deleted sessions across medical units and all time periods of the predetermined time period P does not exceed the maximum number of deletions allowed MAX^{del}. The fourth constraint of the constraints 160 may be represented by:

$${\sum }_{d ∈ D , p ∈ P} {v}_{d , p}^{del} \leq {MAX}^{del} \qquad [ Equation 8 ]$$

A fifth constraint of the constraints 160 may include ensuring that the total number of changes to the preliminary surgery schedule 102 does not exceed the maximum number of changes allowed MAX^{chg}. The fifth constraint of the constraints 160 may be represented by:

$${\sum }_{d ∈ D , p ∈ P} ( {v}_{d , p}^{add} + {v}_{d , p}^{del} ) \leq {MAX}^{chg} \qquad [ Equation 9 ]$$

A sixth constraint of the constraints 160 may include ensuring that the time allocated to surgeries of type s∈S and medical units d∈D in any time period p∈P does not exceed the available time. The assumption is that all sessions are equally long. The sixth constraint of the constraints 160 may be represented by:

$${\sum }_{s ∈ {S}_{d}} {τ}_{s} {θ}_{s , p} \leq session\_length \times {X}_{d , p} ∀ d ∈ D , p ∈ P \qquad [ Equation 10 ]$$

When the number of changes to the preliminary surgery schedule 102 is limited, optimizing a selection of patients 181 and allocating operating room resources 182 may include keeping one or more sessions in the generated schedule for future operating room usage 180 even if the most efficient selection of patients 181 does not use the sessions. Accordingly, some sessions in the generated schedule for future operating room usage 180 may be empty (e.g., no surgery occurring during the session). Optionally, if no empty sessions are desired in the generated schedule for future operating room usage 180, a seventh constraint of the constraints 160 may be used.

The seventh constraint of the constraints 160 may be represented by:

$${\sum }_{s ∈ {S}_{d}} {τ}_{s} {θ}_{s , p} > session\_length \times ( {X}_{d , p} - 1 ) \\ ∀ d ∈ D , p ∈ P \qquad [ Equation 11 ]$$

The number of available beds in each ward may vary in each time period p∈P. For any surgery of a type s∈S and any time period p∈P and p′∈{0, . . . , p-1}, may be 1 if at least one patient who had a surgery s in a time period p′ is still in the hospital in a time period p. B_{s,p′} may be 0 if all patients who had surgery of a type s∈S and any time period p∈P and p′∈{0, . . . , p-1} were discharged prior to a time period p. The above may be represented by the following equation: B_{s,p′}=max{0, min(LOSₛ-p′,1)}, ∀s∈S, p∈P, p′∈{0, . . . , p-1}.

An eighth constraint of the constraints 160 may include ensuring that the number of patients who had surgery, from among the actual and predicted patients of the patient list 170, and may need to use a ward bed overnight does not exceed the number of available ward beds. The eight constraint of the constraints 160 may be represented by:

$${\sum }_{s ∈ S} {\sum }_{{w}_{s} = {w}^{′}} {\sum }_{{p}^{′} ∈ \{ 0 , … , p - 1 \}} {θ}_{s , p - {p}^{′}} \times {B}_{s , {p}^{′}} \leq {b}_{{w}^{′} , p} \\ ∀ p ∈ P , {w}^{′} ∈ W \qquad [ Equation 12 ]$$

A ninth constraint of the constraints 160 may include ensuring that the ICU capacity (e.g., number of available ICU beds) is not exceeded by considering the limit N^{ICU} (e.g., the maximum number of patients that may enter and use an ICU bed per day). The ninth constraint of the constraints 160 may be represented by:

$${\sum }_{s ∈ S} {θ}_{s , p} \times {ICU}_{s} \leq {N}^{ICU} ∀ p ∈ P \qquad [ Equation 13 ]$$

A tenth constraint of the constraints 160 may include tracking the number of overdue patients on the predicted waiting list 170 for each surgery s∈S and in each time period p∈P based on the actual patients on the predicted waiting list 170, the predicted patients of the patient list 170, and the number of patients who had surgery. The tenth constraint of the constraints 160 may be represented by:

$${Ω}_{s , p}^{-} = max \{ \begin{matrix}{\sum }_{{p}^{′} ∈ {P}^{past} , p - {p}^{′} \geq {L}_{{c}_{s}}} {e}_{s , {p}^{′}} + \\ {\sum }_{{p}^{′} ∈ P , p - {p}^{′} \geq {L}_{{c}_{s}}} {a}_{s , {p}^{′}} - {\sum }_{{p}^{′} ∈ P , p - {p}^{′} \leq p} {θ}_{s , {p}^{′}} , 0\end{matrix} \} \\ ∀ p ∈ P , s ∈ S \qquad [ Equation 14 ]$$

An eleventh constraint of the constraints 160 may include tracking the number of actual and predicted patients of the patient list 170 who are still on time at the end of a time period p∈P using the number of actual patients on the patient list 170, the number of predicted patients on the patient list 170, and the number of treated patients of the patient list 170. The eleventh constraint of the constraints 160 may be represented by:

$${Ω}_{s , p}^{+} = {\sum }_{{p}^{′} ∈ {P}^{past}} {e}_{s , {p}^{′}} + {\sum }_{{p}^{′} ∈ P , {p}^{′} \leq p} {a}_{s , {p}^{′}} - {\sum }_{{p}^{′} ∈ P , {p}^{′} \leq p} {θ}_{s , {p}^{′}} - {Ω}_{s , p}^{-} ∀ p ∈ P , s ∈ S \qquad [ Equation 15 ]$$

A twelfth constraint of the constraints 160 may include tracking the number of actual and predicted patients of the predicted waiting list 170 who need surgery and are overdue at the end of a time period p∈P using the number of actual patients of the predicted waiting list 170, the predicted patients of the patient list 170, and the number of actual and predicted patients of the patient list 170 who had surgery in previous time periods p∈P. The twelfth constraint of the constraints 160 may be represented by:

$${Ω}_{s , p} \geq {\sum }_{{p}^{′} ∈ {P}^{past} , p - {p}^{′} \geq {L}_{{c}_{s}}} {e}_{s , {p}^{′}} + {\sum }_{{p}^{′} ∈ P , p - {p}^{′} \geq {L}_{{c}_{s}}} {a}_{s , {p}^{′}} - {\sum }_{{p}^{′} ∈ P , {p}^{′} < p} {θ}_{s , {p}^{′}} , ∀ p ∈ P , s ∈ S \qquad [ Equation 16 ]$$

A thirteenth constraint of the constraints 160 may include tracking the total number of overdue patients, from among the actual and predicted patients of the patient list 170, by computing a difference between the total number of overdue patients at the beginning of a time period p and the total number of overdue patients at the end of the period p∈P. The thirteenth constraint of the constraints 160 may be represented by:

θ_{s,p}⁻=Ω_{s,p}−Ω_{s,p}⁻∀p∈P, s∈S [Equation 17]

A fourteenth constraint of the constraints 160 may include tracking the number of overdue patients, from among the actual and predicted patients of the patient list 170, on a time period p∈P using:

θ_{s,p}⁺=θ_{s,p}−θ_{s,p}⁻∀p∈P, s∈S [Equation 18]

A fifteenth constraint of the constraints 160 may include ensuring that the number of sessions allocated to each medical unit does not exceed the maximum number of sessions allocated to that medical unit in a time period p∈P using:

X_{d,p}≦d_{d}∀d∈D, p∈P [Equation 19]

A sixteenth constraint of the constraints 160 may include ensuring that the total number of sessions allocated to a medical unit in a time period p∈P should not exceed the total number of sessions available. The total number of available sessions may be calculated using the num_sessions sessions per time period p in each operating room. The sixteenth constraint of the constraints 160 may be represented by:

$${\sum }_{d ∈ D} {X}_{d , p} \leq num\_sessions \times {N}^{OT} ∀ p ∈ P \qquad [ Equation 20 ]$$

A seventeenth constraint of the constraints 160 may include considering the availability of specialists during each period. The seventeenth constraint may be represented by:

$${\sum }_{s ∈ {S}_{f}} {K}_{s , p} \times {τ}_{s} \leq {F}_{f , p} \times session\_length \\ ∀ f ∈ F , p ∈ P \qquad [ Equation 21 ]$$

Generating a schedule for future operating room usage 180 may include considering that all category 1 patients, such as actual and predicted patients of the patient list 170, may have surgery on time (e.g., not overdue) but not necessarily ensuring that all category 1 patients have surgery on time. However, if it must be ensured that all category 1 patients, from among the actual and predicted patients of the patient list 170, have surgery on time, generating a schedule for future operating room usage 180 may include using an eighteenth constraint of the constraints 160. The eighteenth constraint of the constraints 160 may be represented by:

$${\sum }_{s ∈ S} {θ}_{s , p}^{-} = 0 , ∀ p ∈ P , s ∈ {S}_{1} \qquad [ Equation 22 ]$$

Generating a schedule for future operating room usage 180 may include considering category 2 and category 3 patients. If additional urgency categories exist, generating a schedule for future operating room usage 180 may include considering the additional urgency categories.

Generating a schedule for future operating room usage 180 by optimizing a selection of patients 181 and allocating operating room resources 182, using the patient list 170, the set of input parameters 101, objective functions 150, and constraints 160 may include determining that the operating room availability of the operating room resources 182 may be insufficient to schedule all actual and predicted patients of the predicted waiting list 170. If it is determined that the operating room availability of the operating room resources 182 is insufficient to schedule all actual and predicted patients of the predicted waiting list 170, generating the schedule for future operating room usage 180 may include increasing the predicted future operating room availability to a point at which it may be sufficient to schedule all actual and predicted patients of the patient list 170 waiting for surgery.

Optimizing a selection of patients 181 and allocating operating room resources 182, using the patient list 170, the set of input parameters 101, objective functions 150, and constraints 160 may include using an optimization solver. Optimizing a selection of patients 181 and allocating operating room resources 182 may include using (e.g., considering) one or more constraints of the constraints 160.

Optimizing a selection of patients 181 and allocating operating room resources 182, using the patient list 170, the set of input parameters 101, objective functions 150, and constraints 160 may include considering the user-specified degree of relative priority 111.

Optimizing a selection of patients 181 and allocating operating room resources 182, using the patient list 170, the set of input parameters 101, objective functions 150, and constraints 160 may include clustering surgeries into clusters of similar surgery types and considering the different types of patient groups within each medical unit using the historical operating room usage data 120 and the expert opinion.

According to an exemplary embodiment of the inventive concept, optimizing a selection of patients 181 and allocating operating room resources 182, using the patient list 170, the set of input parameters 101, objective functions 150, and constraints 160 may include making changes to the preliminary surgery schedule 102. For example, optimizing the selection of patients 181 and allocating the operating room resources 182 may include changing the preliminary surgery schedule 102.

Optimizing a selection of patients 181 and allocating operating room resources 182, using the patient list 170, the set of input parameters 101, objective functions 150, and constraints 160 may include considering hospital resources as being fixed or flexible. Hospital resources include the available surgeons, the ward beds, ICU beds, available operating room time, and the like. A hospital resource such as ward beds may be fixed. Fixed hospital resources such as, for example, ward beds, are resources that may be used by the medical unit that they are allocated to but that are not used by other medical units even if not fully used (e.g., although not all ward beds of a first medical unit are occupied by patients, the available ward beds of the first medical unit cannot be used by a second medical unit in need of additional ward beds). Flexible resources may include hospital resources such as, for example, ward beds that may be shared between medical units. Optimizing a selection of patients 181 and allocating operating room resources 182 may include determining an optimal sharing of hospital resources. For example, vacant ward beds of a first ward may be allocated to second ward in need of additional ward beds, to serve the hospital's needs.

Optimizing a selection of patients 181 and allocating operating room resources 182, using the patient list 170, the set of input parameters 101, objective functions 150, and constraints 160 may include determining a plurality of various optimized schedules 180 that may be generated and/or a plurality of changes that may be made to the preliminary surgery schedule 102. If an optimized schedule 180 cannot be generated or if changes to the preliminary surgery schedule 102 cannot be made, optimizing the selection of patients 181 and allocating the operating room resources 182, using the patient list 170, the set of input parameters 101, objective functions 150, and constraints 160 may include providing information regarding what elements (e.g., the patient list 170, the set of input parameters 101, the objective functions 150, the constraints 160, or a combination thereof) create a conflict and providing suggestions regarding how to modify the above elements to generate a schedule for future operating room usage 180 or to make changes to the preliminary surgery schedule 102. Accordingly, healthcare decision makers may use their knowledge of the hospital's needs, objective functions 150, constraints, and available resources to decide how to modify the above elements when there is a conflict. Multiple goals, including financial targets and complying with regularity controls are considered in optimizing the schedule for future operating room usage 180. The schedule for future operating room usage 180 may include allocation of operating room time to surgeons or departments as well as the selection of types of patients to be treated.

According to an exemplary embodiment of the inventive concept, a schedule for future operating room usage may be generated using a computer system including a processor and a non-transitory, tangible, program storage medium, readable by the computer system, embodying a program of instructions executable by the processor to perform method steps for a method that includes selecting which patients may have surgery and allocating operating room resources needed for the patients' surgeries.

The program of instructions may generate the schedule for future operating room usage by optimizing input data such as a preliminary surgery schedule and a list of patients waiting for surgery, objectives and restraints.

Patients waiting for surgery may be categorized into different treatment (e.g., surgery) categories according to relevant guidelines. The different treatment categories may have different periods of time in which to have surgery performed. If the patients are not operated before their respective periods of time for surgery to be performed, hospital performance evaluation may be negatively affected. Good hospital performance evaluation rating may require that all patient included in the most urgent treatment category need be operated before their respective period of time in which to have surgery performed ends.

The list of patients waiting for surgery may include actual and forecasted patients. The forecasted patients may be determined using historical operating room usage data and statistical mathematical modeling.

Hospital objectives may include maximizing revenue and the number of patients that have surgery before the end of a predetermined time span (e.g., on time), and the like. The constraints may include considering the number of patients that need surgery, the number of available sessions, the surgeons' availability, ward and ICU bed availability, and the like. The mathematical optimization may be performed using an optimization solver.

Input data may include the preliminary surgery schedule created by the hospital, the list of patients, operating room availability, surgeon availability, ICU and ward availability, and the like.

Optimizing patient selection and allocating operating room resources needed for the patients' surgeries may include determining that the predicted future operating room availability is insufficient to schedule all patients of the list of patients waiting for surgery and generating a list of changes that would increase the predicted future operating room availability to a point at which it is sufficient to schedule all patients of the list of patients waiting for surgery.

Optimizing patient selection and allocating operating room resources needed for the patients' surgeries may include clustering surgeries into clusters of similar surgery types.

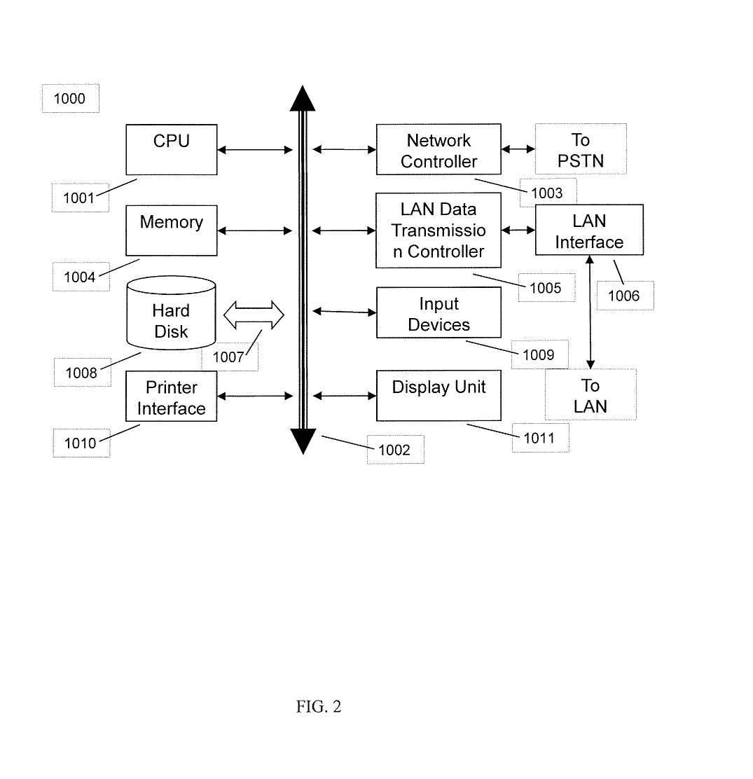

FIG. 2 shows an example of a computer system which may perform the method and system discussed above. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001 (e.g., a processor), random access memory (RAM) 1004, a printer interface 1010, a display unit 1011, a local area network (LAN) data transmission controller 1005, a LAN interface 1006, a network controller 1003, an internal bus 1002, a non-transitory, tangible, and one or more input devices 1009, for example, a keyboard, mouse etc. As shown, the system 1000 may be connected to a data storage device (e.g., a program storage medium), for example, a hard disk, 1008 via a link 1007.

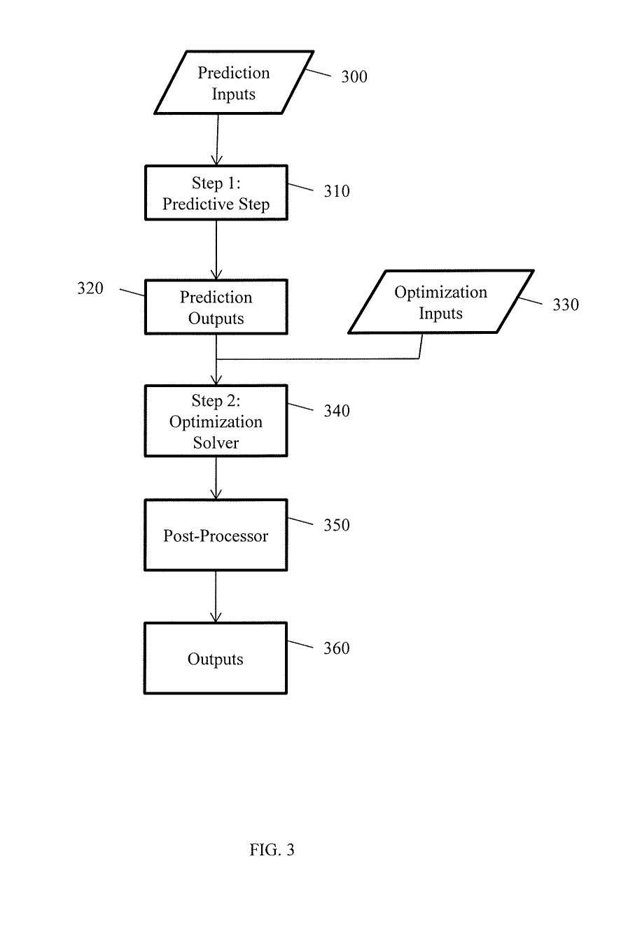

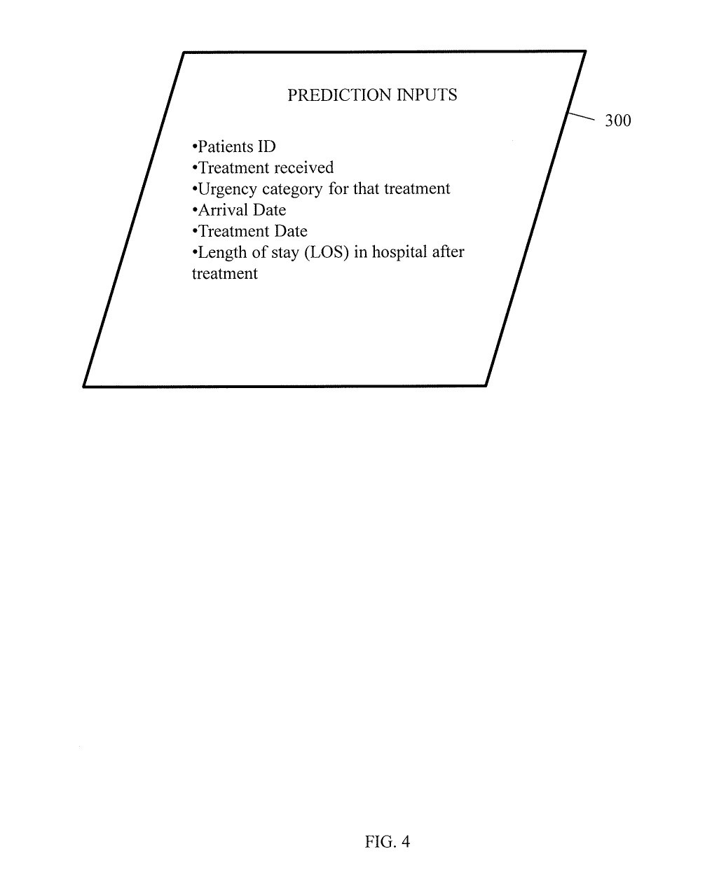

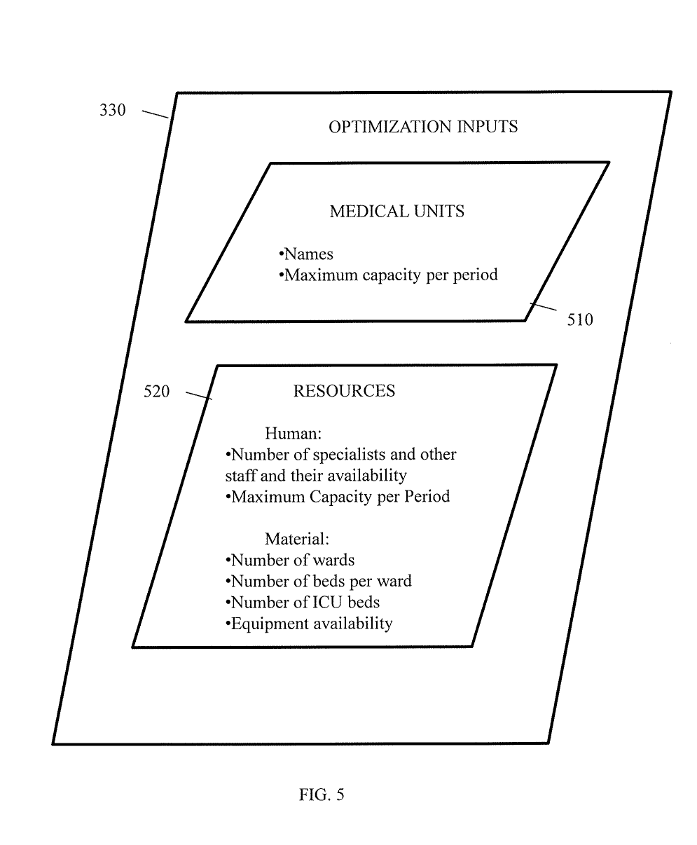

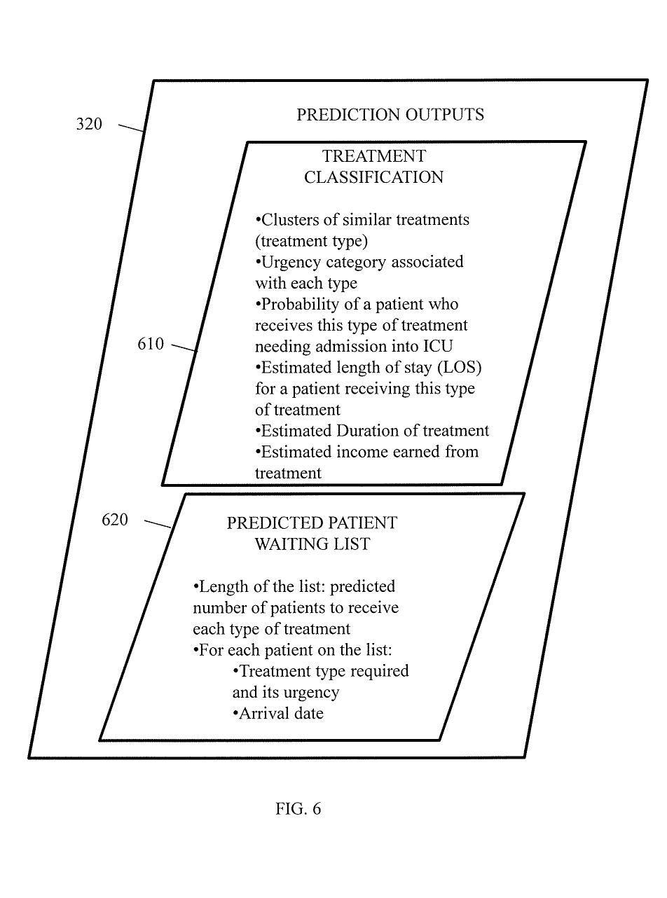

FIG. 3 is a flow chart illustrating steps of a method that may optimize patient selection and allocation of operating room resources needed for the patients' surgeries, according to an exemplary method of the inventive concept. FIG. 4 is a block diagram illustrating the contents of the prediction inputs 300 of the method illustrated FIG. 3, according to an exemplary embodiment of the inventive concept. FIG. 5 is a block diagram illustrating the optimization inputs 330 of the method illustrated in FIG. 3, according to an exemplary embodiment of the inventive concept. FIG. 6 is a block diagram illustrating contents of the prediction outputs 320 of the method illustrated FIG. 3, according to an exemplary embodiment of the inventive concept.

Referring to FIGS. 3 to 6, prediction inputs 300 may be received. The prediction inputs 300 may include data entered to generate prediction outputs 320. Referring to FIG. 4, the prediction inputs 300 may include information about patients who had surgery in the past such as, for example, the previous patients' identification (ID) (e.g., name, age, and the like), the treatment (e.g., surgery) that each previous patient had, an urgency category for each previous patient's surgery type, and the date that each previous patient arrived (e.g., was added to a list of people waiting for surgery). The prediction inputs 300 may include a date when each previous patient had surgery, the length of stay (LOS) of each previous patient in the treatment facility (e.g., hospital) after having surgery, the number of days that each previously treated patient stayed in an ICU bed, and the like. The prediction inputs 300 may be similar to the historical operating room usage data 120.

The step 1: predictive step 310 may include using statistical mathematical modeling and/or expert opinions and the prediction inputs 300 to predict the prediction outputs 320.

Referring to FIG. 6, the prediction outputs 320 may include a treatment (e.g., surgery) classification 610 and a predicted patient waiting list 620. For each patient that may need surgery, the treatment classification 610 may include clusters of similar treatments (treatment type or surgery type), an urgency category associated with each surgery type, and a probability of a patient who receives a type of surgery needing admission into ICU. The treatment classification 610 may include, for each patient that may need surgery, an estimated length of stay (LOS) for a patient receiving the respective type of treatment, an estimated duration of the surgery, an estimated income earned from performing the surgery, and the like.

The predicted waiting list 620 may include a length of a list including a predicted number of patients waiting to have a type of surgery. For each patient on the predicted waiting list 620, a surgery type required, the urgency of the surgery type required, the arrival date (e.g., the forecasted date in which a patient may be added to the predicted waiting list 620) may be determined using the step 1: predictive step 310. Similar surgeries may be considered surgery of the same type.

The prediction outputs 320 may cluster and classify surgeries of the same medical unit and priority, using statistical mathematical modeling, into clusters of similar surgeries for each of the patients in the predicted patient waiting list 620. Similar surgeries may be surgeries of the same type. If a similarity between surgeries exceeds a predetermined threshold or an opinion, the surgeries are not of the same type. The optimization inputs 330 may include input data which may be used in generating the outputs 360.

The optimization inputs 330 may include a time horizon of a specified length, a preliminary plan including a number of sessions allocated to each medical unit on each day, and limits on changes that can be made to the base plan such as, for example, the maximum number of added sessions over the planning horizon, the maximum number of deleted sessions over the planning horizon, the maximum number of total changes (e.g., additions and deletions) over the planning horizon, and the like. The optimization inputs 330 may include the number of patients predicted to join the waiting list on each day during the planning horizon for each treatment type, and a method for allocating performance points based on the percentage of patients for whom the hospital reaches allocated targets (e.g., operates the patients within the time limitation established by guidelines).

The optimization inputs 330 may include a specified number of urgency categories and their targets (e.g., maximum time a patient can spend on the predicted waiting list 620 within the time limitation established by guidelines), and a set of medical departments. Each department may have a number of specialist types associated with it. All specialists within a specialist type may be considered to have identical skills. The number of specialist types may be at equal to or less than the total number of specialists. The optimization inputs 330 may include daily special post-treatment capacity (e.g., ICU capacity), measured in a number of patients. The optimization inputs 330 may include an availability of treatment sessions with respect to daily medical units capacity, budget (e.g., limit on the total number of sessions that may be funded), and a number of treatment facilities (e.g., operating rooms).

The optimization inputs 330 may include an availability of specialists for each medical unit on each day of the planning horizon, and an availability of resources and equipment on each day of the planning horizon (e.g., hospital beds). The optimization inputs 330 may include a set of surgery types, each of which each may have a fixed medical unit, required specialist type, urgency category, expected duration of treatment, expected post-treatment care duration (e.g., length of stay in the hospital), a probability of patients requiring special post-treatment care and for how long (e.g., ICU treatment after the surgery and/or ward beds), and expected funding received by the healthcare provider for performing the treatment (e.g., surgery). The optimization inputs 330 may be similar to the set of input parameters 101.

The step 2: optimization solver 340 may use mathematical optimization, the predicted outputs 320 and the optimization inputs 330, objectives and constraints to select the patients to have surgery on each day of the planning horizon and to plan (e.g., allocate) the number of sessions to be used by each medical unit on each day of the planning horizon. The objectives that may be used in the step 2: optimization solver 340 may be similar to the objectives functions 150, and the constraints that may be used in the step 2: optimization solver 340 may be similar to the constraints 160.

The objectives used in the step 2: optimization solver 340 may have varying weights (e.g., varying importance) or full weight. An objective used in the step 2: optimization solver 340 may also have full weight, (e.g., it must be satisfied in full). For example, ensuring that regulatory guidelines concerning patients' time periods waiting for surgery are fully met (e.g., that all patients in the predicted patient waiting list 620 need be operated before the end of their respective regulatory guidelines for surgery) may be an objective having full weight.

The constraints of the step 2: optimization solver 340 may ensure that the number of treatment sessions of the solution proposed does not exceed the capacity of the provider (e.g., this takes into account the initial number of sessions in the base plan, and the number of changes performed), the number of treatment sessions allocated to each medical unit does not exceed the capacity of that medical unit with respect to specialist numbers and availability, equipment, other personnel, or any relevant regulatory restrictions. The constraints of the step 2: optimization solver 340 may also ensure that the capacity of the medical provider is not exceeded with respect to operating theatre availability, post-treatment care and special care (e.g., ICU care). The constraints of the step 2: optimization solver 340 may ensure that the regulatory constraints are satisfied and performance points correctly measure hospital performance (e.g., constraining a percentage of patients that exceed the time period for surgery established by the regulations).

The post-processor 350 may generate a plurality of plans. A plan may be a generated daily schedule or proposed changes to the preliminary plan of the optimization inputs 330. When no plans can be generated, the post-processor 350 may identify reasons and/or factors causing the unavailability of plan generation and may provide suggestions on modifying the optimization inputs 330, the prediction inputs 300, the objectives and constraints used in the step 2: optimization solver 340 to generate a plan. Accordingly, knowledgeable hospital staff may select modifications to the above elements according to their experience and the hospital's interest.

The outputs 360 may include one or more generated schedules or proposed changes to a preliminary surgery schedule. The one or more generated schedules or proposed changes to a preliminary surgery schedule may be generated using the post processor 350. The one or more generated schedules may include the number of patients to have surgery on each day of the planning horizon and the number of sessions to be used by each medical unit on each day of the planning horizon. The proposed changes to a preliminary surgery schedule may include a number of changes to the preliminary schedule surgery of the optimization inputs 330.

While the present invention has been particularly shown and described with reference to exemplary embodiments thereof, it will be understood by those of ordinary skill in the art that various changes in form and detail may be made therein without departing from the spirit and scope of the present invention.

What is claimed is:

1. A method for optimizing allocation of surgical resources, comprising:
receiving a set of input parameters including a schedule of operating room availability, a list of surgery departments, and a list of patients waiting for surgery and the type of surgery they are waiting for, the list of patients waiting for surgery including patients waiting for a plurality of different types of surgery;
receiving historical operating room usage data;
receiving historical patient waiting list data;
modeling operating room usage based on the received historical operating room usage data and the received historical patient waiting list data;
scheduling future operating room availability based on the list of patients waiting for surgery and the operating room usage model;
scheduling a set of operating room resources required for each of the patients on the list of patients waiting for surgery based on the received historical operating room usage data; and
generating a schedule for future operating room usage to accommodate the list of surgery departments, the list of patients waiting for surgery, and the scheduled future operating room availability by optimizing an assignment of each of the patients waiting for surgery based on respective surgery types and respective scheduled set of operating room resources required.

2. The method of claim 1, wherein generating the schedule for future operating room usage includes allocating operating room time to surgeons or departments, and selecting types of patients to be treated.

3. The method of claim 1, wherein the set of input parameters additionally includes operation urgency data for each patient on the list of patients waiting for surgery and optimizing the assignment of each patient waiting for surgery includes consideration of the operation urgency data.

4. The method of claim 1, wherein the set of input parameters additionally includes a user-specified degree of relative priority for each patient on the list of patients waiting for surgery and optimizing the assignment of each patient waiting for surgery includes consideration of the user-specified degree of relative priority.

5. The method of claim 1, wherein the scheduled future operating room availability includes a number of predicted available hospital beds over time, the scheduled set of operating room resources required for each of the patients includes a prediction of a number of days in which a hospital bed is required, and optimizing the assignment of each patient waiting for surgery includes consideration of the number of predicted available hospital beds over time and the prediction of a number of days in which a hospital bed is required for each patient.

6. The method of claim 1, wherein the received set of input parameters includes data indicating how long each patient on the list of patients waiting for surgery has been waiting for surgery for and optimizing the assignment of each patient waiting for surgery includes consideration of the data indicating how long each patient on the list of patients waiting for surgery has been waiting for surgery for.

7. The method of claim 5, wherein the received set of input parameters includes data describing requirements for maximum waiting times for surgery and optimizing the assignment of each patient waiting for surgery includes ensuring the requirements concerning maximum waiting time for surgery are met.

8. The method of claim 1, wherein optimizing the assignment of each patient waiting for surgery includes making a determination that the generated future operating room schedule is insufficient to schedule all patients of the list of patients waiting for surgery and generating a list of changes that would increase the generated future operating room schedule to a point at which it is sufficient to schedule all patients of the list of patients waiting for surgery.

9. The method of claim 8, wherein the list of changes that would increase the generated future operating room schedule is automatically generated and an impact of the list of changes that would increase the generated future operating room schedule is assessed.

10. The method of claim 1, wherein the schedule of operating room availability received as part of the input parameters includes data pertaining to what types of surgeries are performable in each operating room.

11. The method of claim 1, wherein the historical operating room usage data includes information pertaining to:
past operating room availability;
operating room time required to perform each type of operation; and
extent of hospital stay associated with each type of operation.

12. The method of claim 1, wherein the optimizing of the assignment of each of the patients waiting for surgery is performed by solving a mathematical optimization problem using an optimization solver.

13. The method of claim 1, wherein the scheduled future operating room availability includes a number of predicted available intensive care unit (ICU) hospital beds over time, the scheduled set of operating room resources required for each of the patients includes a prediction of a number of days in which an ICU hospital bed is required, and optimizing the assignment of each patient waiting for surgery includes consideration of the number of predicted available ICU hospital beds over time and the prediction of a number of days in which an ICU hospital bed is required for each patient.

14. The method of claim 1, wherein the types of surgery are clustered into clusters of similar surgery types for similar treatment by the optimization of the assignment of each of the patients waiting for surgery.

15. The method of claim 1, wherein the set of input parameters additionally includes surgeon specialty availability data and surgeon specialty requirements for each surgery type and optimizing the assignment of each patient waiting for surgery includes consideration of the surgeon specialty availability data and the surgeon specialty requirements for each surgery type.

16. The method of claim 1, wherein the list of patients waiting for surgery includes patients forecasted using the historical operating room usage data and statistical mathematical modeling.

17. A computer system comprising:
a processor; and
a non-transitory, tangible, program storage medium, readable by the computer system, embodying a program of instructions executable by the processor to perform method steps for optimizing allocation of surgical resources, the method comprising:
receiving a set of input parameters including:
a schedule of operating room availability;
a list of surgery departments;
a list of patients waiting for surgery and the type of surgery they are waiting for;
operation urgency data for each patient on the list of patients waiting for surgery; and
an indication of hospital bed availability;
receiving historical operating room usage data;
receiving historical patient waiting list data;
modeling operating room usage based on the received historical operating room usage data and the received historical patient waiting list data;
scheduling future operating room availability based on the list of patients waiting for surgery and the operating room usage model;
scheduling a set of operating room resources required for each of the patients on the list of patients waiting for surgery based on the received historical operating room usage data; and
generating a schedule for future operating room usage based on the surgery departments, the list of patients waiting for surgery, the operation urgency data, the indication of hospital bed, and the scheduled future operating room availability by optimizing an assignment of each of the patients waiting for surgery based on respective surgery types and respective scheduled set of operating room resources required.

18. The computer system of claim 17, wherein the received set of input parameters further includes data indicating how long each patient on the list of patients waiting for surgery has been waiting for surgery for and optimizing the assignment of each patient waiting for surgery includes consideration of the data indicating how long each patient on the list of patients waiting for surgery has been waiting for surgery for.

19. The computer system of claim 17, wherein the optimizing of the assignment of each of the patients waiting for surgery is performed by solving a mathematical optimization problem using an optimization solver.

20. The computer system of claim 17, wherein the list of patients waiting for surgery includes patients forecasted using the historical operating room usage data and statistical mathematical modeling.
